(19) United States
(12) Patent Application Publication
(10) Pub. No.: US 2024/0072479 A1
(43) Pub. Date: Feb. 29, 2024

(54) CONNECTOR AND HOUSING USED IN THE SAME

(71) Applicant: Japan Aviation Electronics Industry, Limited, Tokyo (JP)

(72) Inventors: Yukuya MORISHITA, Tokyo (JP); Yusuke OBATA, Tokyo (JP)

(73) Assignee: Japan Aviation Electronics Industry, Limited, Tokyo (JP)

(21) Appl. No.: 18/198,908

(22) Filed: May 18, 2023

(30) Foreign Application Priority Data
Aug. 26, 2022 (JP) 2022-134974

(51) Int. Cl. H01R 13/422

(52) U.S. Cl. CPC H01R 13/422

(57) ABSTRACT

A terminal-accommodation portion of a housing pierces a terminal-holding portion in a front-rear direction. A recess portion pierces the terminal-holding portion in a width direction and is opened upward. The recess portion communicates with the terminal-accommodation portions through an aperture formed in a bottom portion thereof. A latched portion of the terminal-accommodation portion protrudes in the recess portion. A protrusion portion of a retainer is provided with a latching portion and a retaining portion. When the protrusion portion is accommodated in the recess portion, the protrusion portion is positioned upward of the bottom portion of the recess portion. The latching portion is positioned downward of the latched portion. The retaining portion is positioned rearward of and faces a retained portion of a terminal.

### CROSS REFERENCE TO RELATED APPLICATIONS

This application is based on and claims priority under 35 U.S.C. § 119 to Japanese Patent Application No. JP2022-134974 filed Aug. 26, 2022, the contents of which are incorporated herein in their entirety by reference.

### BACKGROUND OF THE INVENTION

This invention relates to a connector, in particular to a structure of a housing used in the connector.

As an example of a connector which is provided with contacts (or terminals) and a housing holding the contacts, a connector disclosed in JP 2015-88405A (Patent Document 1) is known.

Referring to FIGS. 18 to 20, a housing 92 of a connector 90 disclosed in Patent Document 1 has retainers 94 and 95 which prevent contacts 93 from coming out of the housing 92. The retainers 94 and 95 are integrally formed with side walls 921 and 923 of the housing 92, respectively.

As shown in FIG. 18, the retainer 94 has a hinge 941 provided to the side wall 921, a retainer plate 943 and a holding portion 945 provided to the retainer plate 945. Similarly, the retainer 95 has a hinge 951 provided to the side wall 923, a retainer plate 953 and a holding portion 955 provided to the retainer plate 953.

As shown in FIG. 18, the side walls 921 and 923 are formed with apertures 925 and 927, respectively. The apertures 925 and 927 respectively communicate with cavities 931 and 933, each of which accommodates the contact 93. The retainers 94 and 95 are swingable about the hinges 941 and 951, respectively.

As understood from FIGS. 19 and 20, the contacts 93 are accommodated in the cavities 931 and 933 of the housing 92, respectively. In that state, by pushing the retainers 94 and 95 toward the cavities 931 and 933, respectively, the holding portions 945 and 955 protrude into the cavities 931 and 933, respectively, at least in part through the apertures 925 and 927. As a result, the holding portions 945 and 955 are brought into engagement with the contacts 93, and the contacts 93 are prevented from coming out of the housing 92.

### SUMMARY OF THE INVENTION

In the connector 90 of Patent Document 1, swings of the retainers 94 and 95 are repeated whenever the contacts 93 are replaced, and they fatigue the hinges 941 and 951. The fatigued hinges 941 and 951 might be deteriorated and broken depending on a usage environment of them. When the connector 90 is mounted on a car, for example, the contacts 93 would be under a hard usage environment. If the hinges 941 and 951 are deteriorated and broken, the retainers 94 and 95 cannot any longer remain protruding into the cavities 931 and 933 and then come out of the housing 92. As a result, the contacts 93 can come out of the housing 92. Therefore, there is a demand for a connector provided with a housing which can prevent a contact from coming out of the housing even when a hinge of a retainer is fatigued and broken.

It is an object of the present invention to provide a housing which can prevent a contact from coming out of the housing even when a hinge of a retainer is fatigued and broken and to provide a connector provided with the connector.

One aspect of the present invention provides a connector comprising a terminal and a housing. The terminal has a retained portion. The housing has a terminal-holding portion and a retainer. The terminal-holding portion is formed with a terminal-accommodation portion, a recess portion and a latched portion. The terminal-accommodation portion pierces the terminal-holding portion in a front-rear direction. The terminal is inserted in the terminal-accommodation portion from behind in the front-rear direction. The recess portion pierces the terminal-holding portion in a width direction perpendicular to the front-rear direction and is opened upward in an up-down direction perpendicular to both the front-rear direction and the width direction. The recess portion is provided with a bottom portion directed upward in the up-down direction. The bottom portion is formed with an aperture. The recess portion communicates with the terminal-accommodation portion through the aperture. The latched portion protrudes into the recess portion in the front-rear direction. The retainer has an arm portion and a protrusion portion. The arm portion extends from the terminal-holding portion and supports the protrusion portion so that the protrusion portion is movable. The protrusion portion is accommodatable in the recess portion. The protrusion portion is provided with a latching portion and a retaining portion. In a state in which the protrusion portion is accommodated in the recess portion, the protrusion portion is brought into contact with the bottom portion of the recess portion or is positioned upward of the bottom portion of the recess portion in the up-down direction. In the state in which the protrusion portion is accommodated in the recess portion, the latching portion protrudes in the front-rear direction and is positioned downward of the latched portion in the up-down direction. In the state in which the protrusion portion is accommodated in the recess portion, the retaining portion is positioned rearward of the retained portion of the terminal in the front-rea direction and faces the retained portion.

Another aspect of the present invention provides a housing which is used in the aforementioned connector. The housing has a coupling portion coupling the protrusion portion and the terminal-holding portion to each other.

According to the one aspect of the present invention, in the state in which the protrusion portion of the retainer is accommodated in the recess portion of the terminal-holding portion, the latching portion of the protrusion portion protrudes in the front-rear direction and is positioned downward of the latched portion of the terminal-holding portion in the up-down direction. With this structure, even if the arm portion of the retainer is cut apart from the terminal-holding portion, the protrusion portion cannot come out of the recess portion at least in the up-down direction. Meanwhile, the retaining portion of the protrusion portion is positioned rearward of the retained portion of the terminal and faces the retained portion of the terminal. In other words, the retaining portion regulates movement of the retained portion. Thus, even if the arm portion of the retainer is cut apart from the terminal-holding portion, the terminal is prevented from coming out of the housing.

In addition, according to the one aspect of the present invention, the recess portion of the terminal-holding portion pierces the terminal-holding portion in the width direction, so that it is possible to simplify a structure of a mold used for manufacturing the housing. As a result, the aforementioned effect that the terminal is prevented from coming out can be achieved without increasing a manufacturing cost of the housing.

An appreciation of the objectives of the present invention and a more complete understanding of its structure may be had by studying the following description of the preferred embodiment and by referring to the accompanying drawings.

### BRIEF DESCRIPTION OF THE DRAWINGS

FIG. 1 is a front, perspective view showing a connector according to an embodiment of the present invention.

FIG. 2 is a front view showing the connector of FIG. 1.

FIG. 3 is a cross-sectional view showing the connector of FIG. 2, taken along line A-A. A protrusion portion of a retainer and the vicinity thereof are shown on an enlarged scale.

FIG. 4 is a cross-sectional view showing the connector of FIG. 2, taken along line B-B. The protrusion portion of the retainer and the vicinity thereof are shown on an enlarged scale.

FIG. 5 is a front, perspective view showing a housing included in the connector of FIG. 1. The protrusion portion of the retainer and a terminal-holding portion are coupled to each other with a coupling portion.

FIG. 6 is a rear, perspective view showing the housing of FIG. 5.

FIG. 7 is a side view showing the housing of FIG. 5.

FIG. 8 is a front view showing the housing of FIG. 5.

FIG. 9 is a cross-sectional view showing the housing of FIG. 8, taken along line C-C.

FIG. 10 is another front, perspective view showing the housing of FIG. 5. The protrusion portion of the retainer is accommodated in a recess portion of the terminal-holding portion.

FIG. 11 is a rear, perspective view showing the housing of FIG. 10.

FIG. 12 is a side view showing the housing of FIG. 10.

FIG. 13 is a front view showing the housing of FIG. 10.

FIG. 14 is a cross-sectional view showing the housing of FIG. 13, taken along line D-D.

FIG. 15 is a cross-sectional view showing the housing of FIG. 13, taken along line E-E.

FIG. 16 is a front view showing a state in the middle of assembly of the connector of FIG. 1.

FIG. 17 is a cross-sectional view showing the connector of FIG. 16, taken along line F-F. A terminal does not reach a predetermined position. The protrusion portion of the retainer and the terminal-holding portion are coupled to each other with the coupling portion.

FIG. 18 is a cross-sectional view showing a housing used in a connector disclosed in Patent Document 1.

FIG. 19 is a cross-sectional view showing a state in the middle of assembly of the connector disclosed in Patent Document 1.

FIG. 20 is a cross-sectional view showing the connector disclosed in Patent Document 1.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION

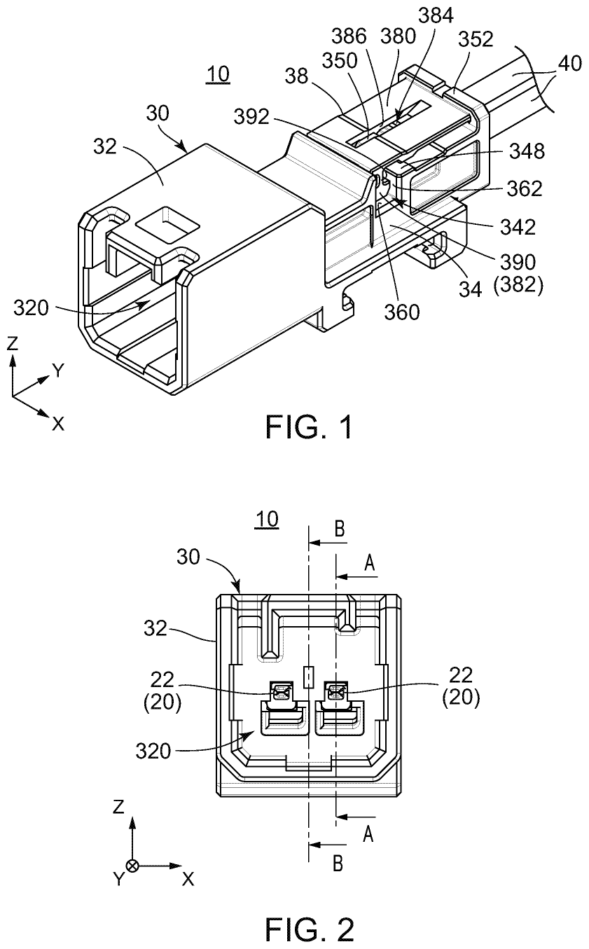

Referring to FIG. 1, a connector 10 according to an embodiment of the present invention is connected to an end of a cable 40. The connector 10 is a connector mateable with a mating connector (not shown) in a front-rear direction. In the present embodiment, the front-rear direction is a Y-direction. A negative Y-direction is directed forward while a positive Y-direction is directed rearward.

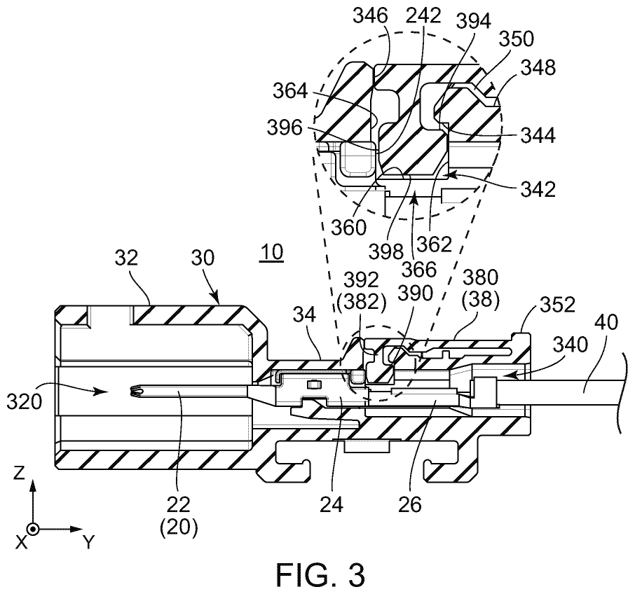

Referring to FIGS. 2 and 3, the connector 10 according to the embodiment of the present invention is provided with a plurality of terminals 20 and a housing 30 which holds the terminals 20. Each of the terminals 20 is made of metal, and the housing 30 is made of insulating resin. In the present embodiment, the terminals 20 are two in number. However, the present invention is not limited thereto. The number of the terminal(s) 20 may be one or three or more.

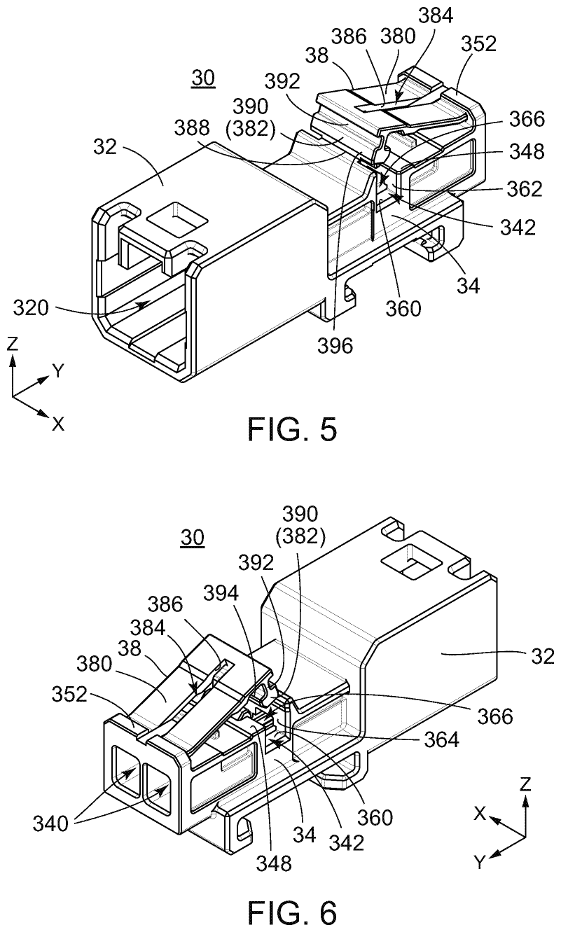

Referring to FIGS. 5 and 6, the housing 30 has a mating portion 32, a terminal-holding portion 34 and a retainer 38. In the present embodiment, the mating portion 32, the terminal-holding portion 34 and the retainer 38 are integrally formed.

As shown in FIGS. 5, 8 and 9, the mating portion 32 is located forward of the terminal-holding portion 34 in the front-rear direction and opened forward. The mating portion 32 defines a receiving portion 320. The receiving portion 320 receives the mating connector (not shown) in part when the connector 10 is mated with the mating connector. In the present embodiment, a shape of the mating portion 32 is generally square when viewed from the front of the mating portion 32. However, the present invention is not limited thereto. The shape of the mating portion 32 may be any shape other than square, such as rectangular, circular or racetrack.

As shown in FIGS. 6 to 9, the terminal-holding portion 34 is formed with a plurality of terminal-accommodation portions 340, a recess portion 342 and a latched portion 344. In the present embodiment, the terminal-accommodation portions 340 are two in number. The terminal-accommodation portions 340 correspond to the terminals 20, respectively. In the present embodiment, the terminal-accommodation portions 340 are arranged in a width direction. In the present embodiment, the width direction is an X-direction.

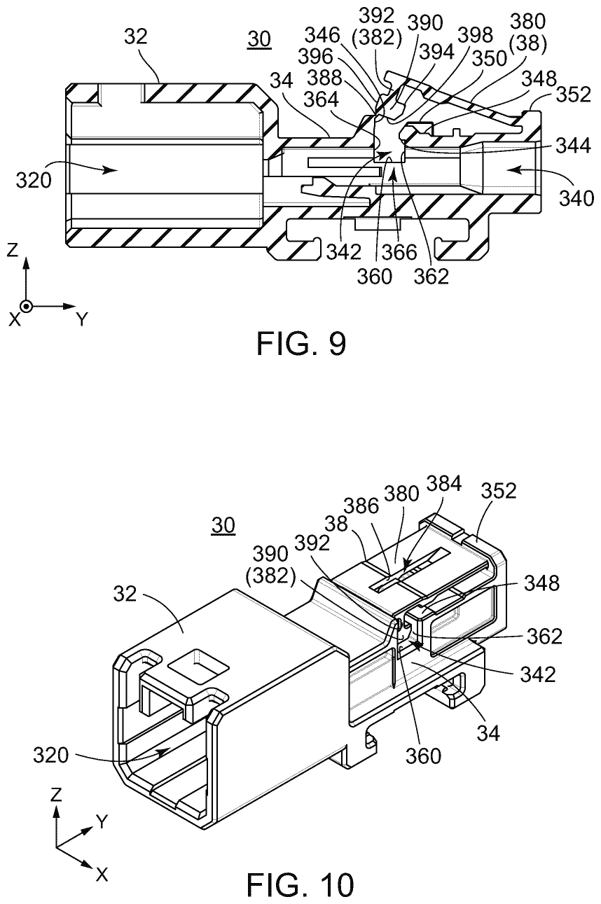

As understood from FIGS. 8 and 9, each of the terminal-accommodation portions 340 pierces the terminal-holding portion 34 in the front-rear direction and communicates with the receiving portion 320 of the mating portion 32. As shown in FIG. 6, a shape of the terminal-accommodation portion 340 is generally rectangular when viewed from behind in the present embodiment. However, the present invention is not limited thereto. The shape of the terminal-accommodation portion 340 may be any shape other than rectangular, such as circular.

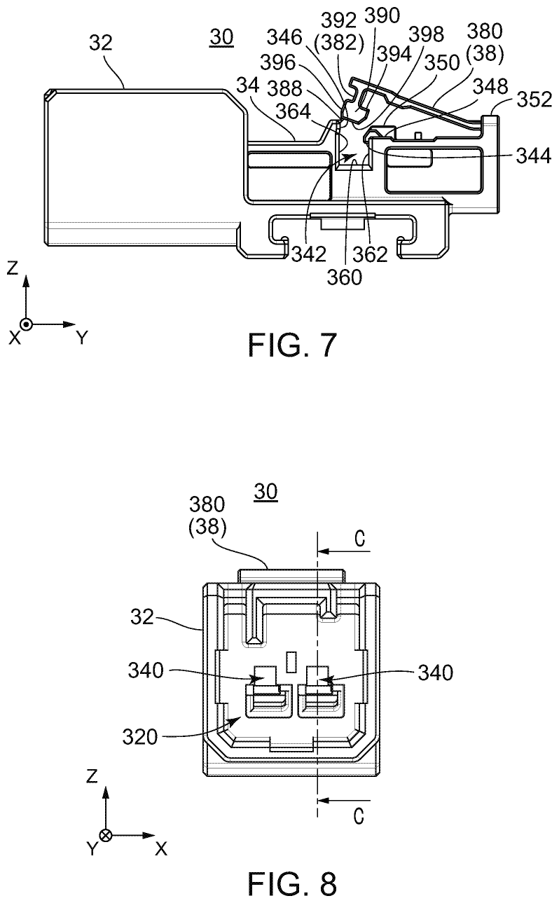

As understood from FIGS. 7 and 9, the recess portion 342 is located roughly in the middle of the terminal-holding portion 34 in the front-rear direction. The recess portion 342 pierces the terminal-holding portion 34 in the width direction perpendicular to the front-rear direction. Moreover, the recess portion 342 is opened upward in an up-down direction perpendicular to both the front-rear direction and the width direction. This structure of the recess portion 342 helps to simplify a structure of a mold used to manufacture the housing 30. In the present embodiment, the up-down direction is a Z-direction. A positive Z-direction is directed upward while a negative Z-direction is directed downward.

As shown in FIGS. 5 and 6, the recess portion 342 is provided with a bottom portion 360 directed upward in the up-down direction. In addition, as shown in FIGS. 7 and 9, the recess portion 342 is provided with a rear wall 362 directed forward in the front-rear direction and a front wall 364 directed rearward in the front-rear direction. As understood from FIGS. 5, 6 and 9, the bottom portion 360 is formed with two apertures 366. The apertures 366 correspond to the terminal-accommodation portions 340, respectively. The recess portion 342 communicates with the terminal-accommodation portions 340 through the apertures 366. The apertures 366 extend upward in the front wall 364 and the rear wall 362, respectively.

As shown in FIGS. 7 and 9, the latched portion 344 is a protrusion provided on the rear wall 362 of the recess portion 342 in proximity to an upper end of the rear wall 362. The latched portion 344 protrudes into the recess portion 342 in the front-rear direction. In the present embodiment, the latched portion 344 is located at a middle portion of the recess portion 342 in the width direction and extends in the width direction. The latched portion 344 reaches neither of ends of the recess portion 342 in the width direction. However, the present invention is not limited thereto. The latched portion 344 may reach both of the ends of the recess portion 342 in the width direction.

As shown in FIGS. 7 and 9, in the present embodiment, the terminal-holding portion 34 is further provided with a guide portion 346. The guide portion 346 is a wall which is contiguous with the front wall 364 of the recess portion 342 and extends upward in the up-down direction. Thus, the guide portion 346 is contiguous with the recess portion 342 and extends upward in the up-down direction from the recess portion 342. In addition, the guide portion 346 faces a latching portion 394 in the front-rear direction.

As shown in FIGS. 5 and 6, in the present embodiment, the terminal-holding portion 34 has a facing upper surface 348 directed upward in the up-down direction. In addition, as shown in FIGS. 7 and 9, the terminal-holding portion 34 is provided with a regulating portion 350. The regulating portion 350 is a plate-like portion protruding upward in the up-down direction from the facing upper surface 348. The regulating portion 350 is located in the middle of the terminal-holding portion 34 in the width direction.

As shown in FIGS. 7 and 9, the retainer 38 has an arm portion 380 and a protrusion portion 382. The arm portion 380 extends from the terminal-holding portion 34. As shown in FIGS. 5 and 6, the arm portion 380 has a generally rectangular plate-like shape, and an end thereof in the longitudinal direction is coupled to a rear-end wall 352 of the terminal-holding portion 34. The arm portion 380 extends at least forward from the rear-end wall 352 of the terminal-holding portion 34. In addition, the arm portion 380 is formed with a slit 384 extending in the longitudinal direction thereof in the present embodiment. Though the arm portion 380 does not have a hinge, at least a part thereof functions as a hinge. In detail, the arm portion 380 is resiliently deformable at least in part and functions as a cantilever spring. Accordingly, the arm portion 380 supports the protrusion portion 382 so that the protrusion portion 382 is movable at least in the up-down direction.

As shown in FIGS. 7 and 9, the protrusion portion 382 of the retainer 38 is provided to the arm portion 380 in proximity to the other end of the arm portion 380 in the longitudinal direction. The protrusion portion 382 of the retainer 38 has a shape long in the width direction. As understood from FIG. 5, the protrusion portion 382 has a fixed cross section in a plane perpendicular to the width direction. In other words, when the protrusion portion 382 is cut along a plane perpendicular to the width direction, it has a same shape regardless of the cutting position. This is for making formation of the protrusion portion 382 easy and making formation of the housing 30 easy. However, the present invention is not limited thereto. The protrusion portion 382 may not have a fixed cross section in a plane perpendicular to the width direction. For example, the protrusion portion 382 may be divided into two in the width direction.

As shown in FIGS. 7 and 9, the protrusion portion 382 has a head portion 390 and a neck portion 392. The neck portion 392 extends from the proximity of the other end of the arm portion 380 in the longitudinal direction and supports the head portion 390. The head portion 390 has a size larger than that of the neck portion 392 in a predetermined direction. In other words, the neck portion 392 has a size smaller than the size of the head portion 390 in the predetermined direction. The predetermined direction is identical with the front-rear direction in a state shown in FIG. 3. In other words, in a state in which the protrusion portion 382 is accommodated in the recess portion 342, the head portion 390 has the size larger than the size of the neck portion 392 in the front-rear direction. When viewed along the width direction, the protrusion portion 382 has a hummer shape. Since the size of the neck portion 392 is smaller than the size of the head portion 390 in the predetermined direction, the neck portion 392 is easily resiliently deformable. Thus, the neck portion 392 supports the head portion 390 so that the head portion 390 is movable with respect to the arm portion 380.

As shown in FIGS. 5, 7 and 9, in the housing 30 at a time when it is shipped as a single piece, the protrusion portion 382 and the terminal-holding portion 34 are coupled to each other with a coupling portion 388. In other words, the housing 30 has the coupling portion 388 which couples the protrusion portion 382 and the terminal-holding portion 34 to each other. The coupling portion 388 has a horizontal portion extending rearward from the guide portion 346 and a vertical portion extending downward from the protrusion portion 382, for example. In that case, a coupling part between the horizontal portion and the vertical portion is relatively thin, so that it is easy to be broken by applying an external force to the retainer 38.

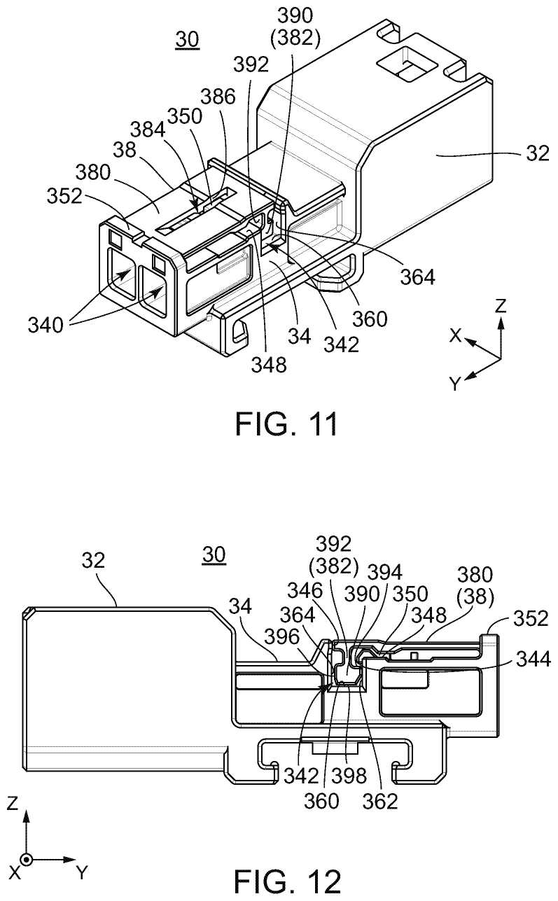

As understood from FIGS. 10 and 11, the protrusion portion 382 of the retainer 38 is accommodatable in the recess portion 342 of the terminal-holding portion 34. In other words, the protrusion portion 382 has a shape and a size which are accommodatable in the recess portion 342. The shape and the size of the protrusion portion 382 are designed so that it is hard or impossible for the protrusion portion 382 to enter and exit from the recess portion 342 unless the arm portion 380 and the neck portion 392 are resiliently deformable. The protrusion portion 382 is provided with the latching portion 394 which prevents the protrusion portion 382 accommodated in the recess portion 342 from exiting from the recess portion 342. In the present embodiment, the latching portion 394 is a part of the head portion 390. In detail, as shown in FIGS. 12, in the state in which the protrusion portion 382 is accommodated in the recess portion 342, the latching portion 394 is a protrusion protruding rearward in the front-rear direction.

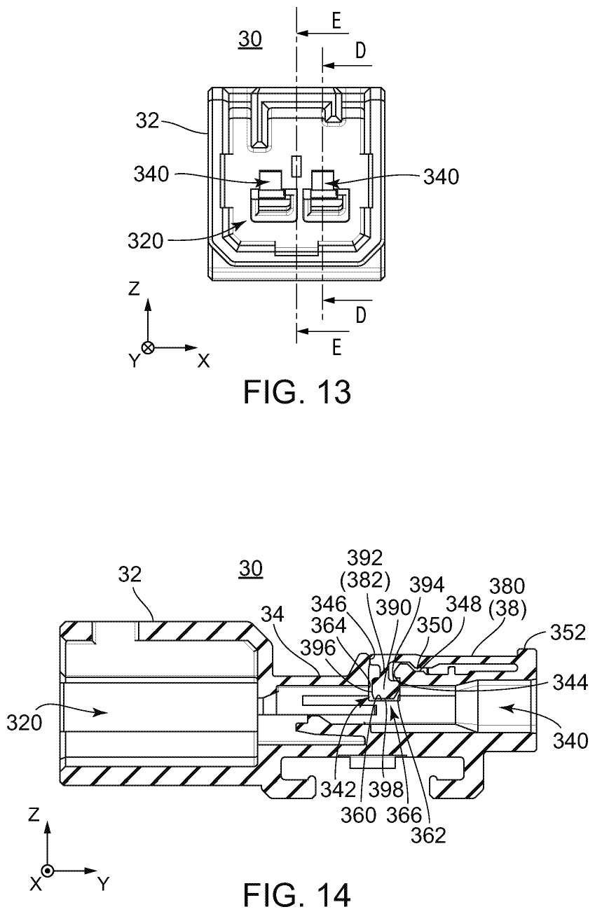

As shown in FIGS. 5 and 7, the protrusion portion 382 is further provided with a retaining portion 396 which prevents the terminals 20 accommodated in the terminal-accommodation portions 340 of the housing 30 (see FIG. 3) from coming out. In the present embodiment, the retaining portion 396 is provided to the head portion 390 of the protrusion portion 382. In detail, the retaining portion 396 is a part of a surface of the head portion 390. As understood from FIGS. 12 to 14, in the state in which the protrusion portion 382 is accommodated in the recess portion 342, the retaining portion 396 is a surface directed forward in the front-rear direction.

As understood from FIGS. 12 and 14, in the present embodiment, the head portion 390 of the protrusion portion 382 has an end face 398 extending in the width direction. In the state in which the protrusion portion 382 is accommodated in the recess portion 342, the end face 398 is positioned at a lowermost end of the protrusion portion 382 in the up-down direction and faces the bottom portion 360 of the recess portion 342.

Referring to FIGS. 7 and 12, upon applying an external force to the arm portion 380 of the retainer 38 to move the protrusion portion 382 of the retainer 38 downward, the arm portion 380 is resiliently deformed, and then the coupling portion 388 coupling the protrusion portion 382 and the terminal-holding portion 34 to each other is broken. As a result, at least downward movement of the protrusion portion 382 of the retainer 38 becomes possible. Additionally, each of the protrusion portion 382 and the terminal-holding portion 34 is left with a broken mark of the coupling portion 388.

As understood from FIGS. 7, 9, 12 and 14, when the protrusion portion 382 of the retainer 38 is accommodated in the recess portion 342 of the terminal-holding portion 34, the neck portion 392 is resiliently deformed. Since the neck portion 392 is resiliently deformed, the latching portion 394 can ride over the latched portion 344 without breaking the protrusion portion 382. At that time, the guide portion 346 of the terminal-holding portion 34 prevents the neck portion 392 from excessively bending and buckling. Thus, the protrusion portion 382 is accommodated in the recess portion 342 of the terminal-holding portion 34 without being broken.

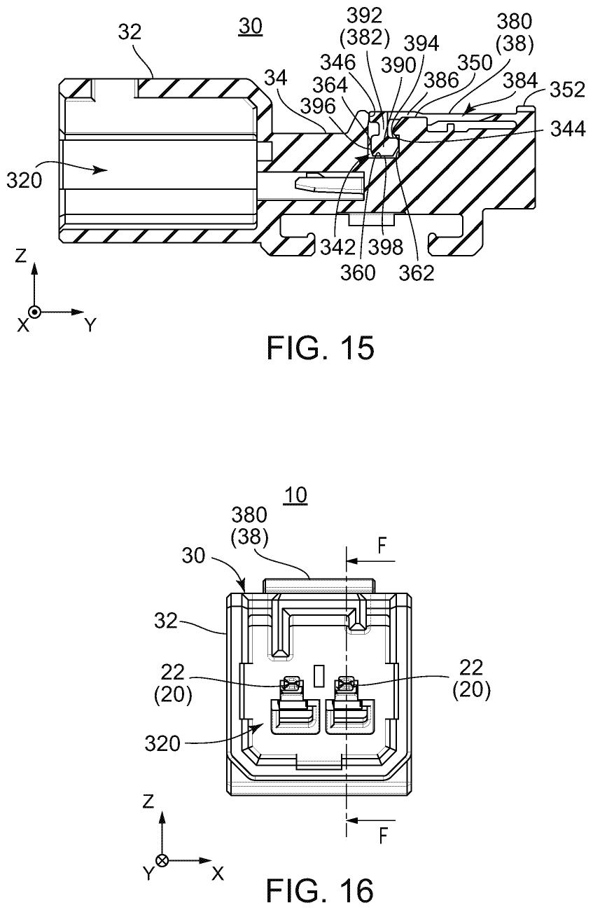

As shown in FIG. 14, in the state in which the protrusion portion 382 of the retainer 38 is accommodated in the recess portion 342 of the terminal-holding portion 34, the facing upper surface 348 faces the arm portion 380. Moreover, as shown in FIGS. 10, 11 and 15, in the state in which the protrusion portion 382 of the retainer 38 is accommodated in the recess portion 342 of the terminal-holding portion 34, the regulating portion 350 is received by the slit 384 at least in part. At that time, the regulating portion 350 faces, in the width direction, each of side-surface portions 386 which form a pair and define the slit 384. When trying to move the arm portion 380 in the width direction in the aforementioned state, the regulating portion 350 is brought into abutment with any one of the side-surface portions 386. In other words, the regulating portion 350 regulates movement of the arm portion 380 with respect to the terminal-holding portion 34 in the width direction. Meanwhile, the side-surface portions 386 of the slit 384 function as regulated portions whose movement is regulated by the regulating portion 350. As just described, the arm portion 380 is provided with the regulated portions, and the regulating portion 350 faces each of the regulated portions in the width direction and regulates the movement of the regulated portions in the width direction.

Referring again to FIG. 3, the terminal 20 has, in order from the front thereof, a contact portion 22, a held portion 24 and a connection portion 26. The contact portion 22 is a part which is brought into contact with a mating terminal (not shown) of the mating connector (not shown). The held portion 24 is a part which is held by the terminal-holding portion 34. The connection portion 26 is a part which is connected to the end of the cable 40. The held portion 24 has a retained portion 242 directed rearward in the front-rear direction. In the present embodiment, the retained portion 242 is a surface directed rearward in the front-rear direction. In the present embodiment, when the terminal 20 is viewed from behind in the front-rear direction as a single piece, the retained portion 242 is visible. Thus, the terminal 20 has the retained portion 242.

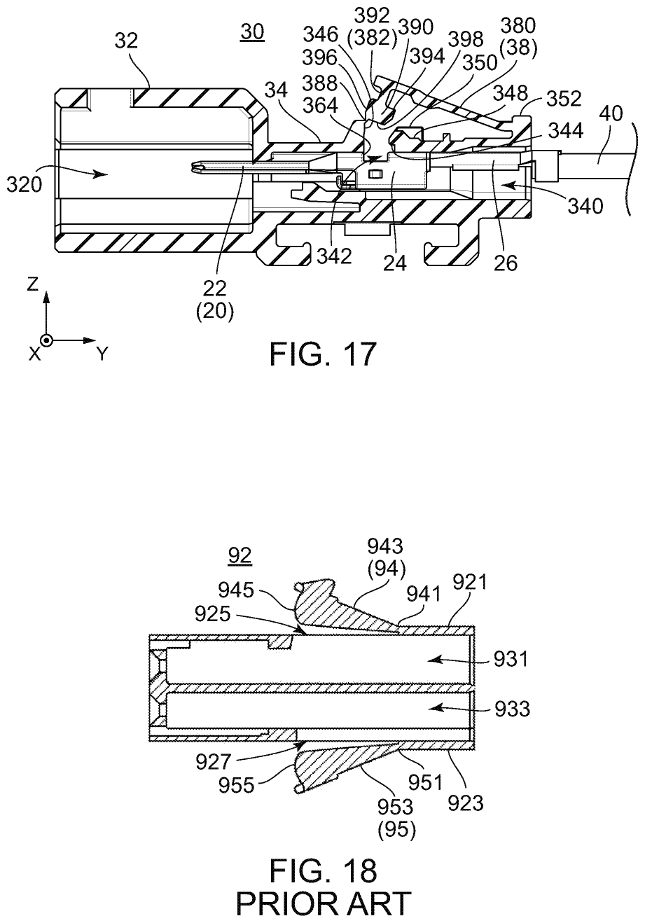

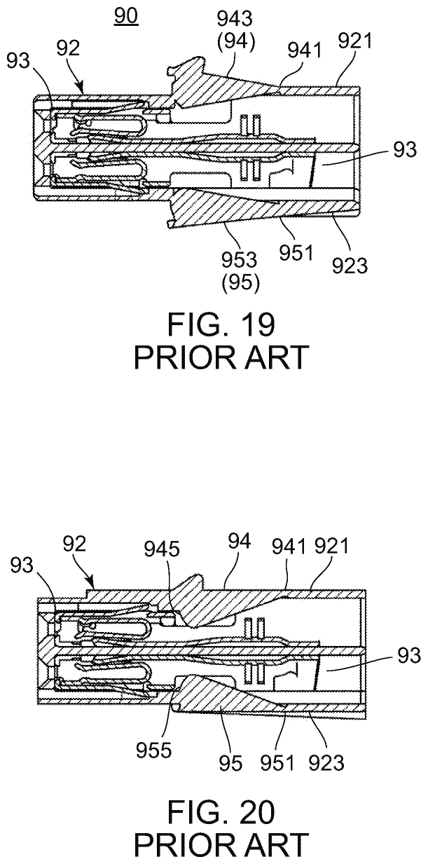

As understood from FIGS. 9, 16 and 17 in addition to FIG. 3, the terminals 20 are inserted into the terminal-accommodation portions 340 of the terminal-holding portion 34, respectively, from behind in the front-rear direction. In the meantime, a part of each of the terminals 20 intersects the recess portion 342 of the terminal-holding portion 34. When the terminal 20 is inserted to a predetermined position, the retained portion 242 is exposed in the recess portion 342 of the terminal-holding portion 34. The retaining portion 396 is located at a position identical to or near the front wall 364 of the recess portion 342 in the front-rear direction. In addition, the retaining portion 396 is at least in part located upward of the bottom portion 360 in the up-down direction.

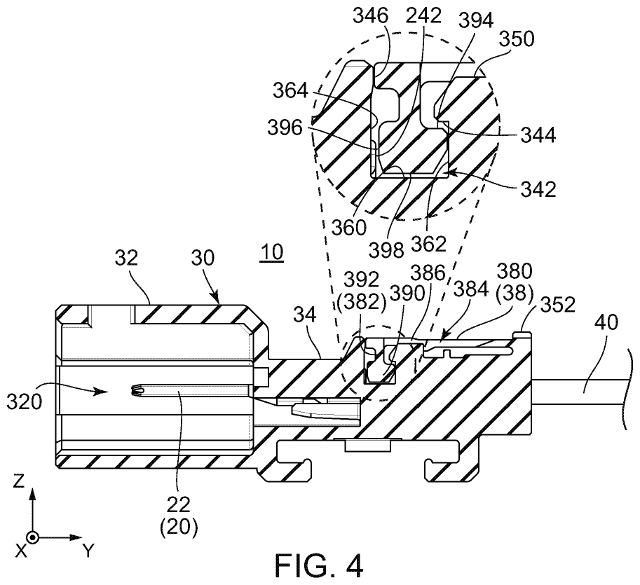

As shown in FIGS. 3 and 4, in the state in which the protrusion portion 382 of the retainer 38 is accommodated in the recess portion 342 of the terminal-holding portion 34, the protrusion portion 382 is brought into contact with the bottom portion 360 of the recess portion 342 or located upward of the bottom portion 360 of the recess portion 342 in the up-down direction. Moreover, in the aforementioned state, the latching portion 394 protrudes in the front-rear direction and is located downward of the latched portion 344 in the up-down direction. Furthermore, in the aforementioned state, the retaining portion 396 is located rearward of the retained portions 242 of the terminals 20 in the front-rear direction and faces the retained portions 242. In addition, an end of the arm portion 380 of the retainer 38 faces the guide portion 346 in the state. With this structure, the retaining portion 396 of the protrusion portion 382 of the retainer 38 regulates rearward movement of the retained portions 242 of the terminals 20 in the front-rear direction. As a result, the terminals 20 are prevented from coming out of the terminal-accommodation portions 340 of the housing 30. On the other hand, the latched portion 344 regulates upward movement of the latching portion 394 in the up-down direction. As a result, the protrusion portion 382 is prevented from exiting from the recess portion 342. This state is maintained even if the part of the arm portion 380, which serves as a hinge, is fatigued and broken. Accordingly, even if the part of the arm portion 380, which serves as a hinge, is fatigued and broken, the terminals 20 are prevented from coming out of the terminal-accommodation portions 340 of the housing 30.

In the present embodiment, the protrusion portion 382 of the retainer 38 has the fixed cross section in the plane perpendicular to the width direction. Moreover, the recess portion 342 of the terminal-holding portion 34 pierces the terminal-holding portion 34 in the width direction. Accordingly, if the protrusion portion 382 accommodated in the recess portion 34 is freely movable in the width direction, the protrusion portion 382 might come out of the recess portion 342. In order to eliminate such a possibility, the terminal-holding portion 34 of the present embodiment is provided with the regulating portion 350 while the arm portion 380 is provided with the regulated portions, or the side-surface portions 386. The regulating portion 350 and the regulated portions regulate the movement of the protrusion portion 382 in the width direction and prevent the protrusion portion 382 from coming out of the recess portion 342. This prevention of the protrusion portion 382 from coming out in the width direction and the aforementioned prevention of the protrusion portion 382 from exiting upward retain the protrusion portion 382 in the recess portion 342 even if the arm portion 380 is broken. Thus, the terminals 20 are prevented from coming out of the housing 30.

Although the specific explanation about the present invention is made above with reference to concrete embodiments, the present invention is not limited thereto but susceptible of various modifications and alternative forms without departing from the spirit of the invention.

Although the regulating portion 350 is the plate-like portion protruding upward from the facing upper surface 348 in the aforementioned embodiment, it may be a columnar or prism protrusion, for example. Moreover, although the slit 384 is used as the regulated portions in the aforementioned embodiment, the regulated portions may be an aperture corresponding to a shape of the regulating portion 350.

In addition, a slit or aperture may be used as the regulating portion 350, and a protrusion corresponding to the slit or aperture may be used as the regulated portions.

Furthermore, wall portions may be provided at both ends of the terminal-holding portion 34 in the width direction as the regulating portion 350, and both edges of the arm portion 380 in the width direction may be used as the regulated portions.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

What is claimed is:

1. A connector comprising a terminal and a housing, wherein:
the terminal has a retained portion;
the housing has a terminal-holding portion and a retainer;
the terminal-holding portion is formed with a terminal-accommodation portion, a recess portion and a latched portion;
the terminal-accommodation portion pierces the terminal-holding portion in a front-rear direction;
the terminal is inserted in the terminal-accommodation portion from behind in the front-rear direction;
the recess portion pierces the terminal-holding portion in a width direction perpendicular to the front-rear direction and is opened upward in an up-down direction perpendicular to both the front-rear direction and the width direction;
the recess portion is provided with a bottom portion directed upward in the up-down direction;
the bottom portion is formed with an aperture;
the recess portion communicates with the terminal-accommodation portion through the aperture;
the latched portion protrudes into the recess portion in the front-rear direction;
the retainer has an arm portion and a protrusion portion;
the arm portion extends from the terminal-holding portion and supports the protrusion portion so that the protrusion portion is movable;
the protrusion portion is accommodatable in the recess portion;
the protrusion portion is provided with a latching portion and a retaining portion;
in a state in which the protrusion portion is accommodated in the recess portion, the protrusion portion is brought into contact with the bottom portion of the recess portion or is positioned upward of the bottom portion of the recess portion in the up-down direction;
in the state in which the protrusion portion is accommodated in the recess portion, the latching portion protrudes in the front-rear direction and is positioned downward of the latched portion in the up-down direction; and
in the state in which the protrusion portion is accommodated in the recess portion, the retaining portion is positioned rearward of the retained portion of the terminal in the front-rea direction and faces the retained portion.

2. The connector as recited in claim 1, wherein:
the protrusion portion has a head portion and a neck portion;
the neck portion extends from the arm portion and supports the head portion;
in the state in which the protrusion portion is accommodated in the recess portion, the head portion has a size larger than a size of the neck portion in the front-rear direction; and
the latching portion and the retaining portion are provided to the head portion.

3. The connector as recited in claim 2, wherein:
the terminal-holding portion is provided with a guide portion; and
the guide portion is contiguous with the recess portion, extends from the recess portion upward in the up-down direction and faces the latched portion in the front-rear direction.

4. The connector as recited in claim 1, wherein:
the protrusion portion has an end face extending in the width direction; and
in the state in which the protrusion portion is accommodated in the recess portion, the end face is positioned at a lowermost end of the protrusion portion in the up-down direction and faces the bottom portion of the recess portion.

5. The connector as recited in claim 1, wherein the protrusion portion has a fixed cross section in a plane perpendicular to the width direction.

6. The connector as recited in claim 1, wherein:
the arm portion is provided with a regulated portion;
the terminal-holding portion is provided with a regulating portion; and
in the state in which the protrusion portion is accommodated in the recess portion, the regulating portion faces the regulated portion in the width direction and regulates movement of the regulated portion in the width direction.

7. The connector as recited in claim 6, wherein:
in the state in which the protrusion portion is accommodated in the recess portion, the terminal-holding portion has a facing upper surface facing the arm portion;
the regulating portion protrudes upward in the up-down direction from the facing upper surface;
the regulated portion is a pair of side-surface portions defining a slit formed in the arm portion; and
in the state in which the protrusion portion is accommodated in the recess portion, the regulating portion is received in the slit at least in part.

8. A housing which is used in the connector as recited in claim 1, wherein the housing has a coupling portion coupling the protrusion portion and the terminal-holding portion to each other.
